(19) United States
(12) Patent Application Publication
(10) Pub. No.: US 2024/0291936 A1
(43) Pub. Date: Aug. 29, 2024

(54) APPARATUS, SYSTEMS, AND METHODS FOR PROVIDING SPATIAL OPTIMIZED ON-VIDEO CONTENT DURING PRESENTATIONS

(71) Applicant: VODIUM, LLC, Nashville, TN (US)

(72) Inventors: MARY MELLOR, Nashville, TN (US); Camille Padilla, Chicago, IL (US)

(21) Appl. No.: 18/572,585

(22) PCT Filed: Jun. 23, 2022
(86) PCT No.: PCT/US2022/034795

§ 371 Date: Dec. 20, 2023

Related U.S. Application Data
(60) Provisional application No. 63/215,080, filed on Jun. 25, 2021.

(51) Int. Cl. H04N 5/272; G06F 3/0481; G06F 3/04845

(52) U.S. Cl. CPC H04N 5/272; G06F 3/0481; G06F 3/04845; G06F 2203/04804

(57) ABSTRACT

Systems and methods as disclosed herein provide on-video content during a video presentation by a user. An electronic device may include or be linked to a display unit and a capture element having a field of view including the user. During execution of one or more applications (e.g., including a web conferencing platform), the device generates in a screen area of the display a first image layer comprising content associated with the presentation, and generates in the screen area a second image layer comprising an at least partially transparent content window, wherein the second image layer at least partially overlaps the first image layer. Content displayed in the content window is provided according to the presentation, and may for example include notes for the user. A generated location of the content window within the screen area is dependent at least in part on a determined location of the capture element.

### TECHNICAL FIELD

The present invention relates generally to systems and methods for providing on-video content. More particularly, an embodiment of an invention as disclosed herein relates to providing on-video content to a presenter, in a manner that may be spatially optimized to provide the appearance of eye contact without altering or otherwise compromising the underlying conferencing platform or equivalent thereof.

### BACKGROUND ART

Numerous problems exist in the art in relation to effective communication, particularly in the field of technology-assisted communication. The COVID-19 pandemic and shift to virtual work has radically changed communication. Despite a majority of work being performed remotely during the pandemic, conventional tools are still unable to sufficiently transform the way people work, and in how they maintain their presence while presenting and communicating virtually, without putting even the most skilled communicators at a disadvantage. It has been estimated that communication is 93% nonverbal, much of which is lost or simply ineffective using existing videoconference systems. There is a weakened rate of social presence over video conference, wherein for example people perceive a lower quality impact of eye contact over video conference and give lower performance ratings over video conference. This means many of the best presenters are already behind. Furthermore, eye contact is critical to communication-increasing trust according to some sources by 10%—but it does not come naturally when presenting virtually. Because people decide whether they find a particular subject interesting or not within the first eight seconds, lost nonverbal communication ability can hinder listener interest. It is hard to convey tone without body language, still harder to maintain eye contact, and almost impossible to immediately capture and retain your audience's attention.

### DISCLOSURE OF THE INVENTION

Embodiments of the present disclosure provide apparatus, systems, and methods for providing on-video content, for example for use during web conferences or videoconferences. Provided herein are apparatus, systems, and methods which resolve issues regarding shortcomings in existing systems.

Implementations consistent with the present disclosure may provide tools to address these challenges of communicating virtually, amongst others, including the ability to juggle multiple tasks and windows at once and the ability to maintain the appearance of eye contact with the camera. This may allow users to focus on their delivery and engaging their audiences in all professions and all settings, Various use cases for technologies described herein may include events, presentations, fundraising, focus groups, meetings, media, and sales. For events, presenters, keynote speakers, and panelists may present flawlessly using the content windows described herein. For presentations, professionals can improve delivery and can stop looking down at their notes by using the content windows described herein. For fundraising, presenters may be permitted to be in control of the conversation by making the ask. For focus groups, a presenter may be the leader by always being engaged of the virtual room. For meetings, a presenter may drive the meeting agenda and ensure they are asking the right questions. For media implementations, a presenter may be permitted to stay on message by not having to memorize talking points. For sales environments, a presenter may be permitted to set the tone and hit the key points in the first five minutes.

Implementations described herein may include a transparent app that allows users to maintain eye contact and reference their notes/script while presenting virtually. This may be used like a teleprompter, allowing users to copy in their speech and read hands free while addressing their audience. Users can also manually control the app to reference things like notes, questions, or key points. By using the technologies described herein, in various exemplary embodiments speakers may be capable of maintaining the appearance of direct eye contact with their audience by positioning their script or notes directly below their webcam.

In an embodiment, a method is disclosed herein for providing on-video content during a video presentation by at least one user. During the execution of one or more applications by an electronic device associated with at least a display unit and a capture element having a field of view including the at least one user, the method includes generating in a screen area of the display unit a first image layer comprising content associated with at least one of the one or more applications, and generating in the screen area of the display unit a second image layer comprising an at least partially transparent content window, wherein the second image layer at least partially overlaps the first image layer. Content displayed in the content window may be provided in accordance with the at least one of the one or more applications. A generated location of the content window within the screen area may be dependent at least in part on a determined location of the capture element.

In an optional aspect according to the above-referenced method embodiment, the location and/or orientation of the content window within the screen area may be automatically generated along a determined line of sight between the capture element and the at least one user.

In so doing, the method may include automatically ascertaining a location of the capture element relative to the screen area, and/or automatically ascertaining a location of the at least one user relative to the capture element.

In another optional aspect according to the above-referenced method embodiment, the location and/or orientation of the content window within the screen area may be dynamically adjustable based on user input from the at least one user.

In another optional aspect according to the above-referenced method embodiment, the content window may be fixed within the screen area at a particular location and/or orientation based on user input from the at least one user.

In another optional aspect according to the above-referenced method embodiment, the content window of the second image layer may be generated with a level of transparency set according to input from the at least one user.

In another optional aspect according to the above-referenced method embodiment, the content may be displayed in the content window according to one or more parameters set via user input from the at least one user.

In another embodiment, a system as disclosed herein provides on-video content during a video presentation by at least one user, with an electronic device comprising a processor functionally linked to at least a display unit and a capture element having a field of view including the at least one user. The processor may be configured, during execution of one or more applications via the electronic device, to direct the performance of operations corresponding to steps in the above-referenced method embodiment and any of the optional aspects thereof.

In one optional aspect according to the above-referenced embodiments, the display unit and the capture element may be integrated into the electronic device.

In another optional aspect according to the above-referenced embodiments, the at least one of the one or more applications may include a web conferencing platform.

In another optional aspect according to the above-referenced embodiments, the second image layer may be generated via execution of an application of the one or more applications separate from the web conferencing platform.

Features described herein may be configured to work with any web conferencing platform, may be configured to require no integration, and may be available for various operating systems, such as for example macOS and Windows.

Various features of the present disclosure may be open and available for anyone for free for a trial period (such as fourteen days, although any term may be used). After expiration of the trial period, the app may prompt the user for an activation key. Individual users can purchase a subscription to the app and receive an activation key, and enterprises can purchase multiple activation keys via an enterprise subscription in various embodiments.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 illustrates an exemplary embodiment of a partial block network diagram according to aspects of the present disclosure.

FIG. 2 illustrates a partial block diagram of an on-video configuration according to aspects of the present disclosure.

FIG. 3 illustrates an alternative partial block diagram of an on-video configuration according to aspects of the present disclosure.

FIG. 4 illustrates an exemplary embodiment of a content window according to aspects of the present disclosure.

FIG. 5 illustrates an exemplary embodiment of a content window including content according to aspects of the present disclosure.

FIG. 6 illustrates an exemplary embodiment of a settings window according to aspects of the present disclosure.

FIG. 7 illustrates an exemplary embodiment of the content window of FIG. 6 for an activated license according to aspects of the present disclosure.

FIG. 8 illustrates an exemplary embodiment of an activation screen during a trial period according to aspects of the present disclosure.

FIG. 9 illustrates an exemplary embodiment of an activation screen after expiration of a trial period according to aspects of the present disclosure.

FIG. 10 illustrates an exemplary embodiment of a subscription verification window according to aspects of the present disclosure.

### BEST MODE FOR CARRYING OUT THE INVENTION

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the implementations consistent with the present disclosure and do not delimit the scope of the present disclosure.

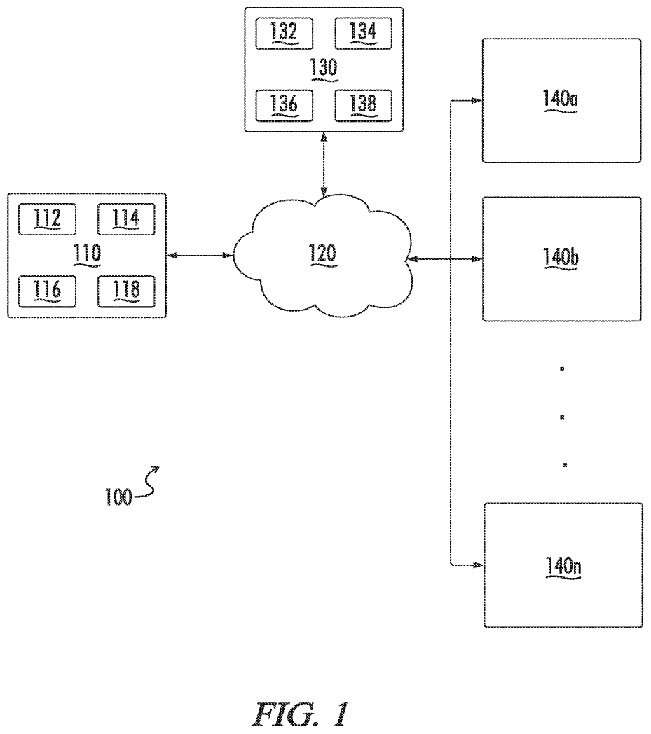

Referring generally to FIGS. 1-10, various exemplary apparatuses, systems, and associated methods according to the present disclosure are described in detail. Where the various figures may describe embodiments sharing various common elements and features with other embodiments, similar elements and features are given the same reference numerals and redundant description thereof may be omitted below.

Various embodiments of an apparatus according to the present disclosure may provide apparatuses, systems, and methods for providing on-video content, for example for use during web conferences or videoconferences.

FIG. 1 illustrates an exemplary embodiment of a partial block network diagram according to aspects of the present disclosure. The system 100 is a simplified partial network block diagram reflecting a functional computing configuration implementable according to aspects of the present disclosure. The system 100 includes a user device 110 coupleable to a network 120, a server 130 coupleable to the network 120, and one or more electronic devices 140a, 140b, . . . , 140n coupleable to the network 120. The server 130 may be a standalone device or in combination with at least one other external component either local or remotely communicatively coupleable with the server 130 (e.g., via the network 120). The server 130 may be configured to store, access, or provide at least a portion of information usable to permit one or more operations described herein. For example, the server 130 may be configured to provide a portal, webpage, interface, and/or downloadable application to a user device 110 to enable one or more operations described herein. The server 130 may additionally or alternatively be configured to store content data and/or metadata to enable one or more operations described herein.

In one exemplary embodiment, the network 120 includes the Internet, a public network, a private network, or any other communications medium capable of conveying electronic communications. Connection between elements or components of FIG. 1 may be configured to be performed by wired interface, wireless interface, or combination thereof, without departing from the spirit and the scope of the present disclosure. At least one of the user device 110 and/or the server 130 may include a communication unit 118, 138 configured to permit communications for example via the network 120. Communications between the communication unit 118, 138 and any other component may be encrypted in various embodiments.

In one exemplary operation, at least one of user device 110 and/or server 130 is configured to store one or more sets of instructions in a volatile and/or non-volatile storage 114, 134. The one or more sets of instructions may be configured to be executed by a microprocessor 112, 132 to perform operations corresponding to the one or more sets of instructions.

In various exemplary embodiments, at least one of the user device 110 and/or server 130 is implemented as at least one of a desktop computer, a server computer, a laptop computer, a smart phone, or any other electronic device capable of executing instructions. The microprocessor 112, 132 may be a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result. Although described as a microprocessor, it should be appreciated that the microprocessor 112, 132 may be any type of hardware and/or software processor or component and is not strictly limited to a microprocessor or to any operation(s) only capable of execution by a microprocessor.

One or more computing component and/or functional element may be configured to operate remotely and may be further configured to obtain or otherwise operate upon one or more instructions stored physically remote from one or more user device 110, server 130, and/or functional element (e.g., via client-server communications or cloud-based computing).

At least one of the user device 110 and/or server 130 may include a display unit 116, 136. The display unit 116, 136 may be embodied within the computing component or functional element in one embodiment and may be configured to be either wired to or wirelessly interfaced with at least one other computing component or functional element. The display unit 116, 136 may be configured to operate, at least in part, based upon one or more operations of the described herein, as executed by the microprocessor 112, 132.

The one or more electronic devices 140a, 140b, . . . , 140n may be one or more devices configured to store data, operate upon data, and/or perform at least one action described herein. One or more electronic devices 140a, 140b, . . . , 140n may be configured in a distributed manner, such as a distributed computing system, cloud computing system, or the like. At least one electronic device 140 may be configured to perform one or more operations associated with or in conjunction with at least one element described herein. Additionally or alternatively, one or more electronic device 140 may be structurally and/or functionally equivalent to the server 130.

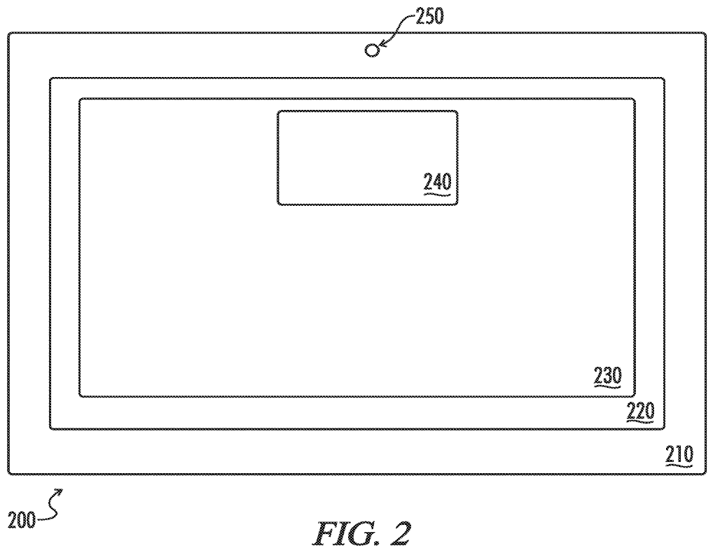

FIG. 2 illustrates a partial block diagram of an on-video configuration according to aspects of the present disclosure. A system 200 may include a display unit 210, for example as previously described with reference to the display unit 116, 136 of the user device 110 and/or server 130. The display unit 210 may include or refer to any type of display device, including but not limited to a television, a smart television, a Liquid Crystal Display (LCD) monitor or screen, a Light-Emitting Diode (LED) monitor or screen, a Cathode-Ray Tube (CRT) monitor or screen, a plasma monitor or screen, a projector, a dynamic billboard or advertising display, a laptop computer or screen, a tablet device or screen, a desktop computer or screen/monitor, a phone display, a smartphone display, or the like, either alone or in combination.

The display unit 210 may include a screen area 220. One or more applications 230 may be visually presented via at least a portion of the screen area 220. The one or more applications 230 may include a web browser, portal, and/or standalone application in various embodiments. The one or more application 230 may be a video or videoconferencing application, webpage, portal, or the like, which is viewable via the display unit 210. The one or more application 230 may include, for example but not limited to, a web conference or videoconferencing software, such as Zoom, ConnectWise Control, BlueJeans Meetings, Microsoft Teams. Google Hangouts Meet, or any other audio, video, or other form of conferencing or communications-capable software or module.

At least one content window 240 may be provided consistent with the present disclosure. The content window 240 may be implemented as a standalone app, as a webpage, a portal, a client software, a thin client, or any other software or communicatively accessible form capable of performing as described herein. A content window 240 may include at least a portion of content which may be visually presented to a user, for example, as an overlay to the one or more application 230. The content window 240 may be configured to visually convey at least a portion of content to a user of the display unit 210. The at least a portion of content may include information relating to or otherwise in association with the one or more application 230. For example, where the application 230 is a videoconferencing application, the content window 240 may visually convey at least one of scripted text or notes corresponding to a presentation to be presented or a discussion via the videoconferencing application, and/or may include additional or other content, such as discussion notes or other information helpful in preparation for, during participation in, or for use after a session of the videoconferencing application.

At least one capture element 250 may be associated with the system 200 and may be configured to capture at least one of audio and/or video information. In various embodiments the capture element may be a camera unit, either with or without an audio capture element such as a microphone to capture audio. The at least one capture element 250 may be a webcam in an exemplary embodiment and may be configured as part of a user device 110, such as a built-in camera and/or microphone on a laptop computer, tablet, smartphone, or other electronic device. The at least one capture element 250 may be configured to capture audiovisual information for use by an application 230, such as a videoconference application. Captured audiovisual information from the at least one capture element 250 may further be used for example to identify or otherwise ascertain a location of a user (e.g., the presenter), as for example within a field of view of images captured by the at least one capture element 250.

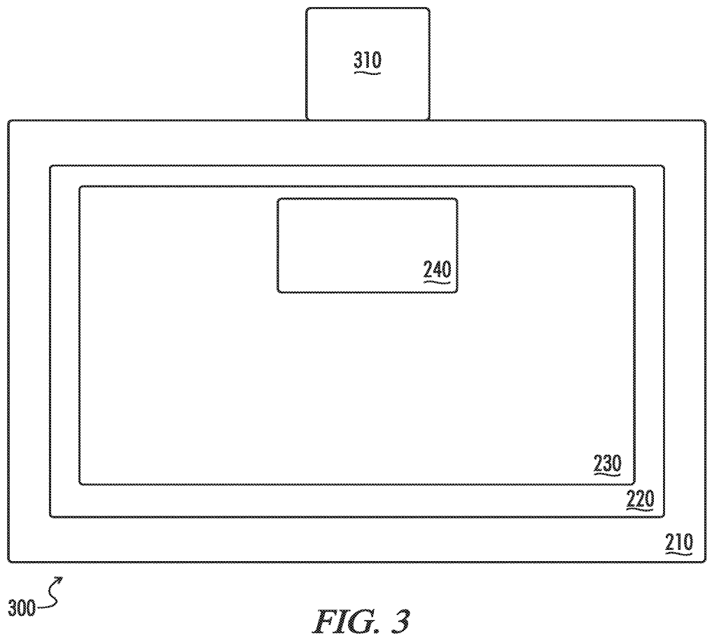

FIG. 3 illustrates an alternative partial block diagram of an on-video configuration according to aspects of the present disclosure. The system 300 includes the display unit 210 of FIG. 2, but with a capture element 310 which is formed as part of the display unit 210. The capture element 310 may be functionally equivalent to the at least one capture element 250 and may optionally be used in conjunction with the at least one capture element 250. The capture element 310 may be physically and/or communicatively coupleable to a user device 110, for example at a display unit 210 thereof. The capture element 310 may be an external webcam, which may be physically remote from the display unit 210 without departing from the spirit and scope of the present disclosure.

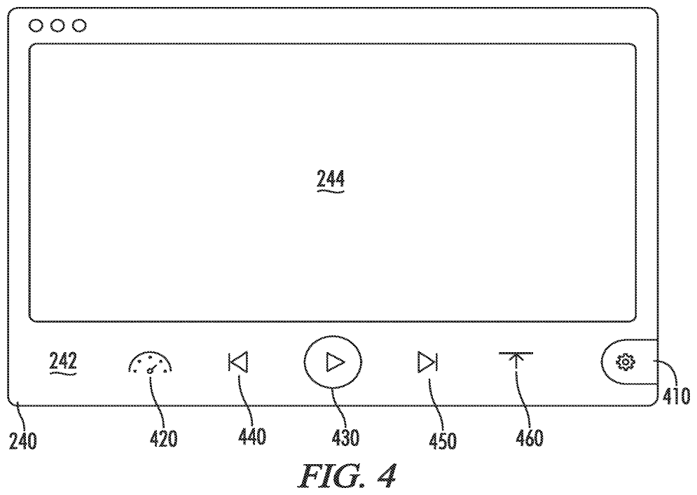

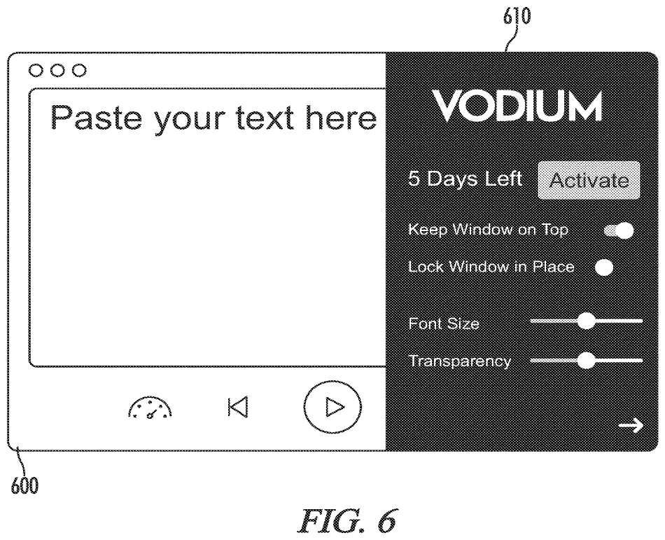

FIG. 4 illustrates an exemplary embodiment of a content window according to aspects of the present disclosure. The content window 240 may include a body 242 and a content section 244. The body 242 may include one or more of a settings section 410, a timing section 420, a play section 430, a reverse section 440, a forward section 450, and/or a return to top section 460. The settings section 410 may be selectable by a user to permit a user to selectively adjust one or more settings associated with the content window 240, for example as illustrated and described herein with reference to FIGS. 6-10. Selection of the timing section 420 may permit a user of the content window 240 to set or adjust a scrolling speed of information within the content section 244. This may be done, for example, using a scroll speed slider or other means of setting or adjusting a scrolling speed within the content section 244. The timing section 420 may be configured in various embodiments to adjust content scrolling within the content section 244 such as to meet a predetermined time period.

The play section 430 may be selected by a user to begin or to pause scrolling or presentation of content within the content section 244. The speed of scrolling within the content section may be adjusted, for example, as previously described with reference to the timing section 420. The reverse section 440 may be used to selectively move between portions of content to be included within the content section 244. This may include, for example, performing a page up operation to show previous content within the content section 244, performing a manual reverse scroll operation, selecting a separate set of content to be presented, for example corresponding to a current or previous slide presented by the user using the application 230, may include reverse scrolling through the content in the content section 244, moving to a previous chapter or set point within the content, or the like. Additionally or alternatively, the reverse section 440 may be used to reverse scroll or move through at least a portion of content presented in the content section 244. The forward section 450 may be used to selectively move between portions of content to be included within the content section 244. This may include, for example, performing a page down operation to show a next set of content within the content section 244, performing a manual scroll forward operation, selecting a separate set of content to be presented, for example corresponding to a current or next slide presented by the user using the application 230, may include scrolling through the content in the content section 244, moving to a next chapter or set point within the content, or the like. Additionally or alternatively, the forward section 450 may be used to move forward through at least a portion of content presented in the content section 244. The return to top section 460 may be used to return to the top of content included within the content section 244.

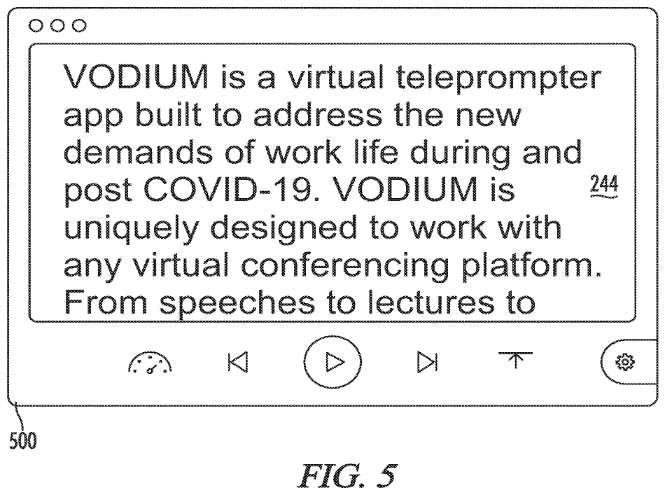

FIG. 5 illustrates an exemplary embodiment of a content window including content according to aspects of the present disclosure. The content window 500 includes text information within the content section 244. Although illustrated as plain text in FIG. 6, it should be appreciated that content which may be presented via the content section 244 may include text, graphics, audio, links to one or more external sources such as weblinks or local device links, or any other form of data or metadata of or relating to presentable or usable information. Content presentable in the content section 244 may be entered manually by a user of the content window 240, 500, may be copy/pasted by a user into the content section 244, may be obtained from a local or remote data storage, and/or may be generated in real-time.

FIG. 6 illustrates an exemplary embodiment of a settings window according to aspects of the present disclosure. The content window 600 includes a settings screen 610. The settings screen 610 may include one or more sections permitting a user to selectively modify one or more settings associated with the content window 240. For example, the settings screen 610 may provide a user with the ability to activate a license for the content window 240, to specify that the content window 240 is always on top of other windows on the user device 110, to lock the content window 240 in place on the screen area 220, to adjust a font size of content within the content section 244 of the content window, and/or to adjust a transparency of at least a portion of the content window.

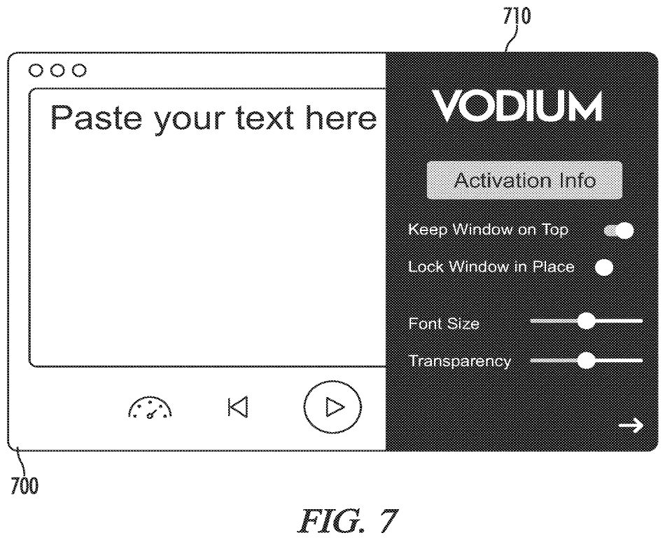

FIG. 7 illustrates an exemplary embodiment of the content window of FIG. 6 for an activated license according to aspects of the present disclosure. The content window 700 may include a settings screen 710 which reflects an activated license and may provide a user-selectable element for the user to view activation information.

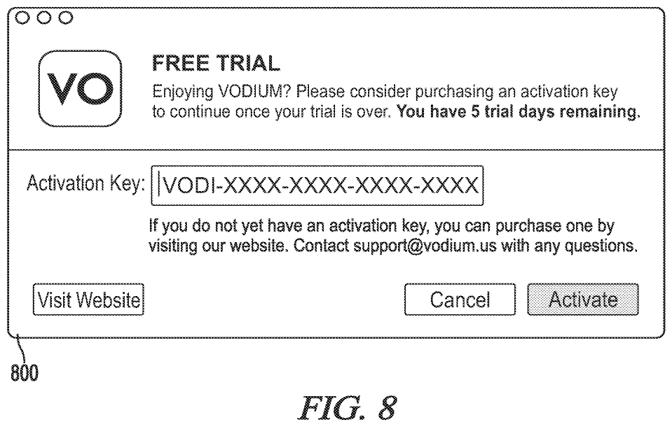

FIG. 8 illustrates an exemplary embodiment of an activation screen during a trial period according to aspects of the present disclosure. An activation window 800 may permit a user to activate a license for a content window 240. Once an activation key is provided by the user, the activation window 800 may be configured to transmit the activation key entered by the user to a verification system. If an entered activation key is accepted by the verification, one or more operations of the content window 240 may be enabled or activated.

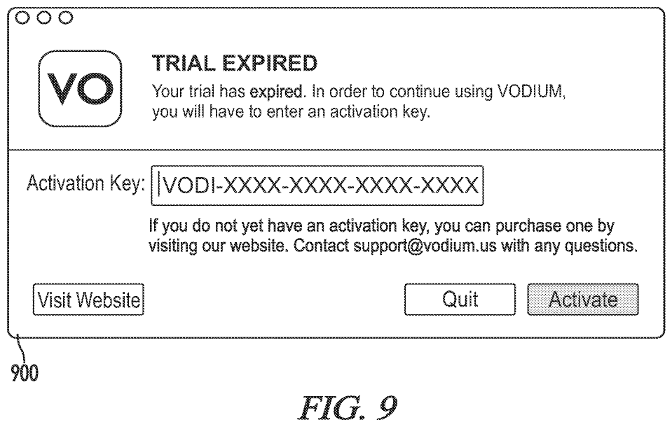

FIG. 9 illustrates an exemplary embodiment of an activation screen after expiration of a trial period according to aspects of the present disclosure. An activation window 900 may permit a user to activate a license for a content window 240. Once an activation key is provided by the user, the activation window 900 may be configured to transmit the activation key entered by the user to a verification system. If an entered activation key is accepted by the verification, one or more operations of the content window 240 may be enabled or activated.

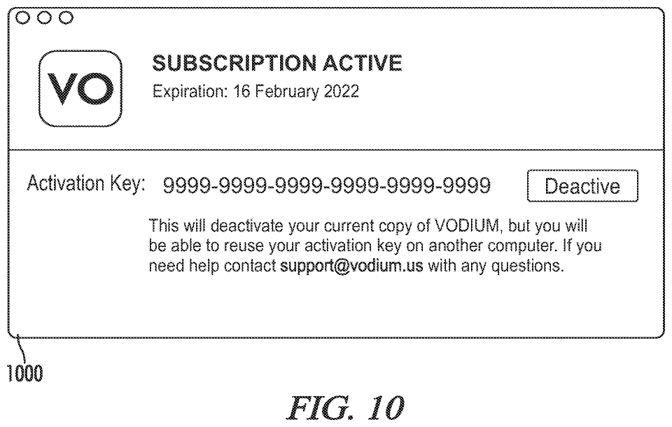

FIG. 10 illustrates an exemplary embodiment of a subscription verification window according to aspects of the present disclosure. A subscription activation window 1000 may include information relating to an active subscription, such as an expiration date, an activation key, a deactivation section to deactivate a current copy of the content window 240, or any other information or metadata relating to a subscription or status.

Implementations consistent with the present disclosure may include a transparent app that sits on top of video conferences allowing a user to maintain eye contact and to reference notes while presenting virtually, including but not limited to the VODIUM® app.

Though not required for operation, it may be possible to provide third party platform integrations and/or implementations consistent with the present disclosure. For example, integrations of an application or platform as disclosed herein with web conferencing providers such as Zoom, Google Meet, and/or Microsoft Teams meetings, or direct implementations thereby of an invention as disclosed herein, may be initiated or joined from a hosted interface by way of a user selection, such as a button (or input for joining via meeting code). Furthermore, call functionality of existing web conference providers may be provided within a hosted app within the scope of the present disclosure, and using the hosted interface. One or more features described herein may be provided via one or more third parties, such as web conference providers, by implementing at least a portion of code in conjunction with a Software Development Kit (SDK) of the web conference provider software, for example by utilizing a web conference provider software to integrate with the hosted application (e.g., VODIUM). Implementations consistent with the present disclosure may include the ability to connect to a calendar, for example to include access meetings and details via a calendar connection. Social media integration may be provided alongside a calendar integration. For example, a user may be permitted to connect to a calendar and/or to obtain information from a calendar to find people in a meeting and then scrape their social media accounts and optionally display facts about them within the app.

One or more dynamic advertisements may be provided in an integration of third-party advertising and messaging materials with respect to a hosted application as disclosed herein. Automatic scrolling may be provided for a set period of time in various embodiments. For example, a user may select how long they have to speak, and the hosted app may be configured to automatically select a scroll speed to fill and hit the allotted amount of time. Text may be saved locally within the hosted app in various exemplary embodiments. Users may be provided with the ability to connect with their personal or business cloud solution(s) to access and import text from documents. Users may further be provided with the ability to access documents from a desktop, for example by providing the ability for users to and import text from documents from their website.

Implementations consistent with the present disclosure may further provide white labeling by providing, among others: the ability for enterprise customers to integrate logo and brand colors within the hosted app; the ability for enterprise or Events customers to integrate sponsor logos, colors, and text within the hosted app; the ability for platform providers to fully white label the hosted app such that the interface looks like its own platform interface; and the like.

Implementations consistent with the present disclosure may include the content window 240 being capable of both a light and a dark mode, for example as used to select and/or modify one or more color or brightness settings associated with at least a portion of the content window 240. Users may be provided with the ability to switch from dark mode to light mode and vice-versa. The app may include a timer feature which provides the ability for users to set timer that counts up to help with pacing of speeches or presentations. The app may further include a recording feature which provides the ability to record speeches within the hosted application and store recordings locally within the app. A watermark feature may provide the ability to display logo or watermark to let virtual audiences know users are using the app in certain scenarios.

Implementations consistent with the present disclosure may include a remotely controlled content window which provides the ability for one user to access and control another user's app, including uploading and editing text and controlling the scrolling and all settings (e.g., via local or internet communication(s) between the user device 110 and another user's device). One or more embodiments may include the ability to control a hosted scroll parameter (e.g., speed, location, timing) using one or more keyboard shortcuts. Content within the content window 240 may include the ability to implement rich text formatting, such as bold, italicize, and underline text, as well as bullet and number. Users may further be provided with the ability to provide pacing marks within the app to see how far text will move when using the tap to scroll buttons.

To facilitate the understanding of the embodiments described herein, a number of terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. The terminology herein is used to describe specific embodiments consistent with the present disclosure, but their usage does not delimit the present disclosure, except as set forth in the claims. The phrase “in one embodiment,” as used herein does not necessarily refer to the same embodiment, although it may.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The previous detailed description has been provided for the purposes of illustration and description. Thus, although there have been described particular embodiments of a new and useful invention, it is not intended that such references be construed as limitations upon the scope of this invention except as set forth in the following claims.

1. A method for providing on-video content during a video presentation by at least one user, the method comprising, during execution of one or more applications by an electronic device associated with at least a display unit and a capture element having a field of view including the at least one user:
generating in a screen area of the display unit a first image layer comprising content associated with at least one of the one or more applications;
generating in the screen area of the display unit a second image layer comprising an at least partially transparent content window, wherein the second image layer at least partially overlaps the first image layer,
wherein content displayed in the content window is provided in accordance with the at least one of the one or more applications, and
wherein a generated location of the content window within the screen area is dependent at least in part on a determined location of the capture element.

2. The method of claim 1, wherein the location and/or orientation of the content window within the screen area is automatically generated along a determined line of sight between the capture element and the at least one user.

3. The method of claim 2, further comprising automatically ascertaining a location of the capture element relative to the screen area.

4. The method of claim 2, further comprising automatically ascertaining a location of the at least one user relative to the capture element.

5. The method of claim 1, wherein the location and/or orientation of the content window within the screen area is dynamically adjustable based on user input from the at least one user.

6. The method of claim 1, wherein the content window is fixed within the screen area at a particular location and/or orientation based on user input from the at least one user.

7. The method of claim 1, wherein the content window of the second image layer is generated with a level of transparency set according to input from the at least one user.

8. The method of claim 1, wherein the content is displayed in the content window according to one or more parameters set via user input from the at least one user.

9. A system for providing on-video content during a video presentation by at least one user, the system comprising:
an electronic device comprising a processor functionally linked to at least a display unit and a capture element having a field of view including the at least one user,
wherein the processor is configured, during execution of one or more applications via the electronic device, to:
generate in a screen area of the display unit a first image layer comprising content associated with at least one of the one or more applications;
generate in the screen area of the display unit a second image layer comprising an at least partially transparent content window, wherein the second image layer at least partially overlaps the first image layer,
wherein content displayed in the content window is provided in accordance with the at least one of the one or more applications, and
wherein a generated location of the content window within the screen area is dependent at least in part on a determined location of the capture element.

10. The system claim 9, wherein the display unit and the capture element are integrated into the electronic device.

11. The system of claim 9, wherein the at least one of the one or more applications comprises a web conferencing platform.

12. The system of claim 11, wherein the second image layer is generated via execution of an application of the one or more applications separate from the web conferencing platform.

13. The system of claim 9, wherein the location and/or orientation of the content window within the screen area is automatically generated along a determined line of sight between the capture element and the at least one user.

14. The system of claim 13, wherein the processor is further configured to automatically ascertain a location of the capture element relative to the screen area.

15. The system of claim 13, wherein the processor is further configured to automatically ascertain a location of the at least one user relative to the capture element.

16. The system of claim 9, wherein the location and/or orientation of the content window within the screen area is dynamically adjustable based on user input from the at least one user.

17. The system of claim 9, wherein the content window is fixed within the screen area at a particular location and/or orientation based on user input from the at least one user.

18. The system of claim 9, wherein the content window of the second image layer is generated with a level of transparency set according to input from the at least one user.

19. The system of claim 9, wherein the content is displayed in the content window according to one or more parameters set via user input from the at least one user.
